(19) United States
(12) Patent Application Publication
(10) Pub. No.: US 2016/0125997 A1
(43) Pub. Date: May 5, 2016

(54) APPARATUS FOR DISSIPATING HEAT OF INDUCTOR

(71) Applicant: HYUNDAI MOBIS CO., LTD., Seoul (KR)

(72) Inventor: Soo Bin HWANG, Yongin-si (KR)

(73) Assignee: HYUNDAI MOBIS CO., LTD., Seoul (KR)

(21) Appl. No.: 14/924,796

(22) Filed: Oct. 28, 2015

(30) Foreign Application Priority Data
Oct. 31, 2014 (KR) 10-2014-0150191

(51) Int. Cl. H01F 27/22; H01F 27/28

(52) U.S. Cl. CPC H01F 27/22; H01F 27/2804

(57) ABSTRACT

Provided is an apparatus for effectively dissipating heat generated by an inductor of a DC-DC converter, and allowing for reducing a size and a weight of the DC-DC converter to thereby reduce manufacturing cost. The apparatus for dissipating heat of an inductor includes an inductor configured to protrude to outside; and a heat sink configured to be installed outside of the inductor and to receive the inductor.

### CROSS-REFERENCE TO RELATED APPLICATIONS

This application claims priority under 35 U.S.C. §119 to Korean Patent Application No. 10-2014-0150191, filed on Oct. 31, 2014, the disclosure of which is incorporated herein by reference in its entirety.

### TECHNICAL FIELD

The present invention relates to heat dissipation of an inductor, and more particularly, to an apparatus for effectively dissipating heat generated by an inductor of a DC-DC converter.

### BACKGROUND

In general, an electric device using electric energy such as a starting system or an ignition system is used in automobiles. Recently, as vehicles have been electromagnetically controlled, most systems provided in vehicles have become electrified and electronized.

Also, as various facilities for increasing vehicle convenience and using information technology have been increasingly grafted into vehicles, electric devices using electric energy has been on the rise.

In a hybrid electric vehicle (HEV), a DC-DC converter is installed to supply power to an electric component load. In general, a DC-DC converter is a device serving as an alternator of a vehicle. That is, the DC-DC converter converts high voltage side power into low voltage side power and supplies energy to an electric component load and charge a battery.

The DC-DC converter converts high voltage side power into low voltage side power through a power module, a transformer, and an output rectifying diode, and here, power loss is made in various power elements, which leads to heat generation.

The transformer includes an inductor, and in order to dissipate heat generated by the inductor to an outside when the DC-DC converter operates, a related art is configured as illustrated in FIG. 1.

FIG. 1 is a view illustrating a structure for installing an inductor of a related art DC-DC converter. The related art DC-DC converter 10 has a structure in which a housing 13 is installed in a printed circuit board (PCB) 12 on which an inductor 11 is mounted, to hermetically seal the inductor 11.

In order to effectively dissipate heat generated by the inductor 11 outwardly, a heat sink 20 is attached to the PCB 12.

Thus, according to the related art, heat generated by the inductor 11 is dissipated by a convection current in a space within the DC/DC converter 10 or dissipated by the heat sink 20.

However, heat dissipation by a convection current is less effective in terms of cooling than heat dissipation by conduction, and also, since heat is dissipated using the PCB 12 in the lower end of the inductor 11, heat dissipation efficiency is not good, which leads to a rapid increase in temperature of the inductor 11 to result in a limitation of output power.

Also, since the inductor 11 is mounted on the PCB 12, a size of the housing 13 forming an appearance of the DC-DC converter 10 is determined by a height of the inductor 11, making the inductor 11 an element determining a size of the DC-DC converter 10, and here, since the inductor 11 is larger than other components, there is a limitation in reducing the size of the DC-DC converter 10.

### SUMMARY

Accordingly, the present invention provides an apparatus for effectively dissipating heat generated by an inductor of a DC-DC converter.

In one general aspect, an apparatus for dissipating heat of an inductor includes: an inductor configured to protrude to an outside; and a heat sink configured to be installed outside of the inductor and to receive the inductor.

The apparatus may further include: a printed circuit board (PCB) on which the inductor is mounted; and a housing configured to hermetically seal an internal component mounted on the PCB.

The internal component may be mounted on a first surface of the PCB and the inductor may be mounted on a second surface opposing the first surface of PCB.

The heat sink may include a receiving unit for receiving the inductor.

An edge of an entrance of the receiving unit may be rounded with a predetermined curvature.

The edge of the entrance of the receiving unit may be chamfered with a predetermined with and a predetermined slope.

A thermal grease may be applied to the interior of the receiving unit.

The thermal grease may be at least one of a ceramic-based thermal grease, a metal-based thermal grease, a carbon-based thermal grease, a fusible metal-based thermal grease.

A solder cream may be applied between the receiving unit and the inductor.

The inductor may be in contact with an inner surface of the receiving unit.

Other features and aspects will be apparent from the following detailed description, the drawings, and the claims.

### BRIEF DESCRIPTION OF THE DRAWINGS

FIG. 1 is a view illustrating an inductor installation structure of the related art DC-DC converter.

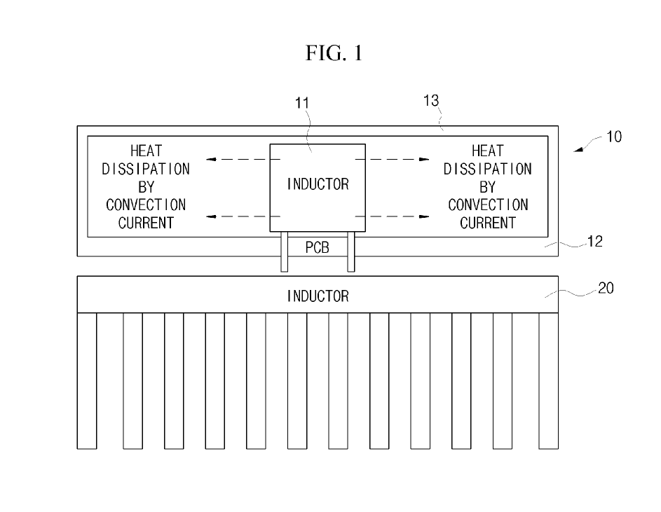

FIG. 2 is a view illustrating a configuration of a DC-DC converter having an inductor heat dissipation apparatus according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the specification, like numbers refer to like elements.

In describing embodiments of the present invention, a detailed description of known techniques associated with the present invention unnecessarily obscure the gist of the present invention, it is determined that the detailed description thereof will be omitted. Moreover, the terms used henceforth have been defined in consideration of the functions of the present invention, and may be altered according to the intent of a user or operator, or conventional practice. Therefore, the terms should be defined on the basis of the entire content of this specification.

Hereinafter, an inductor heat dissipation apparatus of a DC-DC converter and a DC-DC converter having the same according to an embodiment of the present invention will be described in detail.

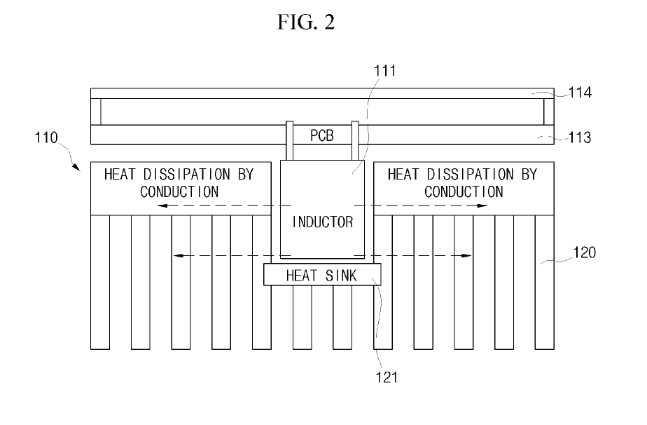

FIG. 2 is a view illustrating a configuration of a DC-DC converter having an inductor heat dissipation apparatus according to an embodiment of the present invention.

Referring to FIG. 2, a DC-DC converter 110 having an inductor heat dissipation apparatus an inductor 111 and a heat sink 120 installed outside of the inductor 111.

The DC-DC converter 110, a device installed in an electric vehicle and to convert high voltage side power into a low voltage side power, includes an internal component such as a power module, or the like.

The inductor 111 and the internal component are mounted on a PCB 113. The internal component is sealed by a housing 114 so as to be protected from external moisture, dust, and the like.

Thus, in the DC-DC converter 110 according to the present invention, the inductor 111 is exposed to outside of the housing 114.

The heat sink 120 is installed on outside of the inductor 111 and serves to effectively dissipate heat generated by the inductor 111 exposed to the outside.

The heat sink 120 includes a receiving unit 121 for receiving the inductor 111. Here, a thermal grease may be coated within the receiving unit 121 of the heat sink 120.

The thermal grease may be one of a ceramic-based thermal grease, a metal-based thermal grease, a carbon-based thermal grease, a fusible metal-based thermal grease.

The receiving unit receives the inductor 111, and here, the inductor 111 may be received by the receiving unit 121 according various coupling schemes.

In order to prevent the inductor 111 from being damaged by the receiving unit 121 when received by the receiving unit 121, edges of an entrance of the receiving unit 121 may be rounded with a predetermined curvature or may be chamfered to have a predetermined width and a predetermined slope.

For example, the inductor 111 may be received by the receiving unit 121 in a shrink-fit manner, and when the inductor 111 is received by the receiving unit 121 in the shrink-fit manner, the inductor 111 is brought into contact with an inner surface of the receiving unit 121.

In another example, the inductor 111 may be received by the receiving unit 121 through soldering, and here, a solder cream may be applied between the receiving unit 121 and the inductor 111 and cured to receive the inductor 111 in the receiving unit 121.

According to the configuration of the present invention, since the inductor 111 is received in the heat sink 120, an area in which the inductor 111 is in contact with the heat sink 120 increases, effectively spreading heat generated by the inductor 111.

Also, according to the present invention, since the inductor 111 protrudes to outside of the housing 113, a size of the housing 113 may be reduced, reducing a size and a weight of the DC-DC converter and manufacturing cost thereof.

According to the present invention, in order to receive an inductor of a DC-DC converter, a receiving unit is formed in a heat dissipation apparatus and the inductor of the DC-DC converter is received in the receiving unit.

Thus, since the inductor is received in the heat dissipation apparatus, an area in which the inductor is in contact with the heat dissipation apparatus increases, effectively spreading heat generated by the inductor.

Also, since the inductor protrudes to the outside, a size of the housing may be reduced, which leads to a reduction in a size and a weight of a DC-DC converter and a reduction in manufacturing cost.

The heat dissipation apparatus has been described according to the embodiments, but the scope of the present invention is not limited to a specific embodiment. The present invention may be corrected and modified within the technical scope obvious to those skilled in the art.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for dissipating heat of an inductor, the apparatus comprising:
an inductor configured to protrude to an outside; and
a heat sink configured to be installed outside of the inductor and to receive the inductor.

2. The apparatus of claim 1, further comprising:
a printed circuit board (PCB) on which the inductor is mounted; and
a housing configured to hermetically seal an internal component mounted on the PCB.

3. The apparatus of claim 2, wherein the internal component is mounted on a first surface of the PCB and the inductor is mounted on a second surface opposing the first surface of PCB.

4. The apparatus of claim 1, wherein the heat sink includes a receiving unit for receiving the inductor.

5. The apparatus of claim 4, wherein an edge of an entrance of the receiving unit is rounded with a predetermined curvature.

6. The apparatus of claim 4, wherein the edge of the entrance of the receiving unit is chamfered with a predetermined with and a predetermined slope.

7. The apparatus of claim 4, wherein a thermal grease is applied to the interior of the receiving unit.

8. The apparatus of claim 7, wherein the thermal grease is at least one of a ceramic-based thermal grease, a metal-based thermal grease, a carbon-based thermal grease, a fusible metal-based thermal grease.

9. The apparatus of claim 4, wherein a solder cream is applied between the receiving unit and the inductor.

10. The apparatus of claim 4, wherein the inductor is in contact with an inner surface of the receiving unit.
